(19) United States
(12) Patent Application Publication
(10) Pub. No.: US 2007/0163420 A1
(43) Pub. Date: Jul. 19, 2007

(54) Interchangeable decorative covers for guitar components

(76) Inventors: Stuart Reiss, Medford, NY (US); Thomas Giannandrea, Nesconset, NY (US)

Correspondence Address: ALFRED M. WALKER, 225 OLD COUNTRY ROAD, MELVILLE, NY, 11747-2712, US

(21) Appl. No.: 11/331,562

(22) Filed: Jan. 14, 2006

(51) Int. Cl. G10D 3/00

(52) U.S. Cl. 84/329

(57) ABSTRACT

An interchangeable cover covers the front viewable face of a body and/or a headstock of a guitar. The removable cover has an outline corresponding to an outline of the front face of the guitar body and/or headstock. Fasteners are provided along a periphery of each removable cover to attach each respective cover to the front viewable face of the body and or headstock of the guitar. The covers may have decorative apertures filled with a replaceable decorative insert, such as one or more pieces of mosaic inlay, a rastered image engraved on a rear portion thereof, multiple apertures with replaceable decorative inserts with different design features or a strip light embedded in the face of the body, with the cover being transparent over an area above the strip light. Preferably the periphery of each cover has a rounded and polished edge.

### FIELD OF THE INVENTION

The present invention relates to interchangeable, decorative covers for a guitar body or guitar head stock.

### BACKGROUND OF THE INVENTION

Guitar bodies include a top layer connected to a bottom layer, preferably plastic or wood, which are connected by a continuous raised, serpentine edge wall. Often the guitar top layers are colored with decorative materials by lamination or spray painting, or have inlaid pieces inlaid therein. U.S. Pat. No. 5,305,674 of Fishman describes a permanently laminated finish edge integral with the top layer of the guitar, with optional design elements embedded below the laminate material and on the wood or plastic top layer of a guitar.

U.S. Pat. No. 6,911,590 of Childress discloses a guitar made of interchangeable structural pieces, but not with interchangeable covers.

U.S. Pat. No. 6,791,017 of Oskorep discloses a magnetic plate attached to a guitar top layer, for magnetically holding a plurality of magnetic guitar picks thereto.

U.S. Pat. No. 6,231,196 of Mahachek describes a laser marking process and products made therefrom in general.

Additionally, pick guards are cover areas which cover the portion of the top layer of the guitar most likely to be impacted and damaged by pick contacts and chipping damage. While they are decorative, they do not cover the entire guitar body with an interchangeable substrate cover which masks the entire top layer of either the guitar body or the distal end head stock.

### OBJECTS OF THE INVENTION

It is therefore an object of the present invention to provide interchangeable decorative covers for guitar components.

It is also an object of the present invention to provide interchangeable design elements within the surface of a guitar body cover or guitar head stock cover.

Other objects which become apparent from the following description of the present invention.

### SUMMARY OF THE INVENTION

The present invention is for decorative cover masks for guitar parts, such as the guitar body or the string peg head stock at the distal end of a guitar neck spanning the head stock and the main guitar body. Unlike permanent laminated substrates painted on to a cover, the covers of the present invention are discrete decorative covers, affixed by screws or other fasteners, so that in their preferred embodiment they may be interchangeable with other alternate covers for the guitar body or head stock.

The decorative body top covers are made of a variety of decorative, preferably acrylic sheets, such as of

a) marbled acrylics,

b) glittered acrylics,

c) mirrored acrylics,

d) clear acrylics, and/or,

e) wood, or,

f) combinations thereof.

In order not to interfere height-wise with the guitar strings, the dimensional thickness is in a range of from range 1/16″ to ¼, preferably ⅛ inch thick.

When using thin Abalone (paua) shell material in a portion of the covers, the covers can be no larger than 1/16 to 1/32, and brought up to the ⅛ level of the cover

Other decorative materials used may include “Mother of pearl” laminate shell material laminated onto the acrylic cover sheet.

The decorative cover tops are made of different shapes to accommodate different guitar shapes.

A further option is that the cover itself has cutout inserts, which are interchangeable. Laser cutting is made through the body cover, such as, for example, marble acrylic, to provide a hole for insertion of the insert, and further laser rastering is done of the preferred design (i.e. eagle, rainbow, etc). Laser rastering is a process done with the laser from the back of a mirrored or acrylic sheet, that scrapes away a thin layer of an opaque portion thereof to reveal an etched design that can only be felt from the back, but which can be seen through the front.

Especially in mirrored covers, the rear opaque portion of the mirror can be etched away with laser mastering from the back of the cover substrate. Therefore, first laser cutting makes the recess hole and then laser rastering the inlay design.

A further alternate embodiment includes raised or recessed mirror inlays, wherein the raised inlays can extend above the top surface of the guitar top cover or head stock cover.

Another optional is the use of urethane sealing material, especially if the guitar body cover or head stock cover is made of wood.

A further design option is a circumferential border integrated with the body or head stock cover, with interchangeable designs

Preferred options include engraved rastering, such as described in U.S. Pat. No. 6,231,196 of Mahachek for a laser marking process and products made therefrom.

Additional options include other recessed, flush or raised inlays in the cover, which may or not be removable.

Further options include a transparency or translucency provided to the cover, with one or more curved, linearly extending strip lights inlayed with a power source under the transparent or translucent cover. The lights may also be fluorescent luminescent lights trips with an internal power source.

A key feature is a polished, radiused rounded edge provided along the edge of the covers, to provide smooth transitions to the guitar body or head stock body. The edge is first made curved and arcuate with a hand-held router sander, such as a ⅛ inch Dremel brand router sander with a ⅛ inch round-over bit. Then the curved surface is finely polished by hand with wet sand grit paper to a high sheen. The wet sand grit paper may be selected from sandpaper having a range of from number 300 to number 5000 sandpaper, preferably number 2500 sand paper combinations thereof.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of a guitar body 20 and distal end string peg head stock 60 shown with respective decorative covers 200 and 600 attached thereto, with the body 20, neck 40 and head stock 60 of the guitar 10 shown in dotted lines, shown for environmental purposes only;

FIG. 2 is an exploded view of the guitar body cover 200, pick-up covers 300, and head stock cover 600;

FIG. 3 is a crossectional detail view showing the fastening of the guitar body cover 200 to the upper guitar body wood surface plate 22, taken along view lines “3-3” of FIG. 1;

FIG. 4 is an alternative crossectional detail view showing the fastening of the guitar body cover 200 to the upper wood guitar body 20 utilizing a screw and insert anchor.

FIG. 5 is a crossectional detail view of a portion of the radius edge 210 of the guitar body cover 200; taken along lines “5-5” of FIG. 1;

FIG. 6 is a perspective view of a pick-up decorative cover plate 300;

FIG. 7 is an exploded perspective view of an alternate embodiment for a guitar body cover 200, showing an interchangeable replacement insert plate 700 for decorative images 710 and/or logos fit into an aperture 220 of cover 200.

FIG. 8 is a crossectional detail view of et oval shaped insert 700 of FIG. 7, taken along view lines “8-8” of FIG. 7;

FIG. 9 is an exploded perspective view of an alternate embodiment for a guitar body cover 200, with interchangeable replacement portions 720 for decorative images and/or logos; wherein the insert 700 has an mosaic-style portion pieces 730 inlaid therein;

FIG. 10 is a crossectional close-up detail view of the mosaic-embedded insert 720 of FIG. 9, taken along view lines “10-10” of FIG. 9;

FIG. 11 is an exploded perspective view of an alternate embodiment for a guitar body cover 200, with interchangeable replacement insert plate 700 for decorative images and/or logos; wherein the insert 700 has an engraved rastered image 740 therein;

FIG. 12 is a crossectional detail view of the insert 700 as in FIG. 11, taken along view lines “12-12” of FIG. 11;

FIG. 13 is a perspective view of a full body cover 200 for a guitar body 10, shown with mosaic-style inlays 760, 770 insertable into cutout 750 therein;

FIG. 14 is a perspective view of a full guitar body cover 200, shown with curved strip lights 780 buried in the wood guitar body 20, visible through the transparent body cover 200.

FIG. 15 is a perspective view of a guitar body top cover 200 with a contoured surface portion 240 for contoured guitar bodies;

FIG. 16 is a perspective view of a guitar body top cover 200 showing a two piece assembly 200, 250 to fit contoured guitar bodies;

FIG. 17 is a top plan view of an alternative guitar body cover embodiment 202 for an acoustic guitar.

FIG. 18 is an exploded perspective view of an alternate embodiment 2 piece body cover 204a, 204b for a flying V style guitar body 20.

FIG. 19 is a perspective view of a guitar head stock cover 610 with a flush inlay insert image 612;

FIG. 20 is a perspective view of a guitar head stock cover 620 with a raised inlay insert image 622 FIG. 21 is a perspective view of a guitar head stock cover 630 with a reverse side raster cut image 632;

FIG. 22 is a perspective view of a pick guard cover 800 with laser cutting 802;

FIG. 23 is a crossectional view thereof, taken along view lines “23-23” of FIG. 22;

FIG. 24 is a crossectional detail view of an arcuate radiused edge 810 of a guitar cover; taken at 24-24 of FIG. 22;

FIG. 25 is a perspective view of a pick guard cover 800 with engraved rastered imaging 808;

FIG. 26 is close-up crossectional detail view thereof, taken along view lines “26-26” of FIG. 25; and,

FIG. 27 is an exploded perspective view of a kit with a plurality of covers for various parts of a guitar.

### DETAILED DESCRIPTION OF THE PREFERRED EMBODIMENTS

The interchangeable decorative covers of this invention, which can vary in material from mirrored acrylic to a glitter or marble look and even wood, decorate the top surface of the guitar body and can incorporate matching head stock covers.

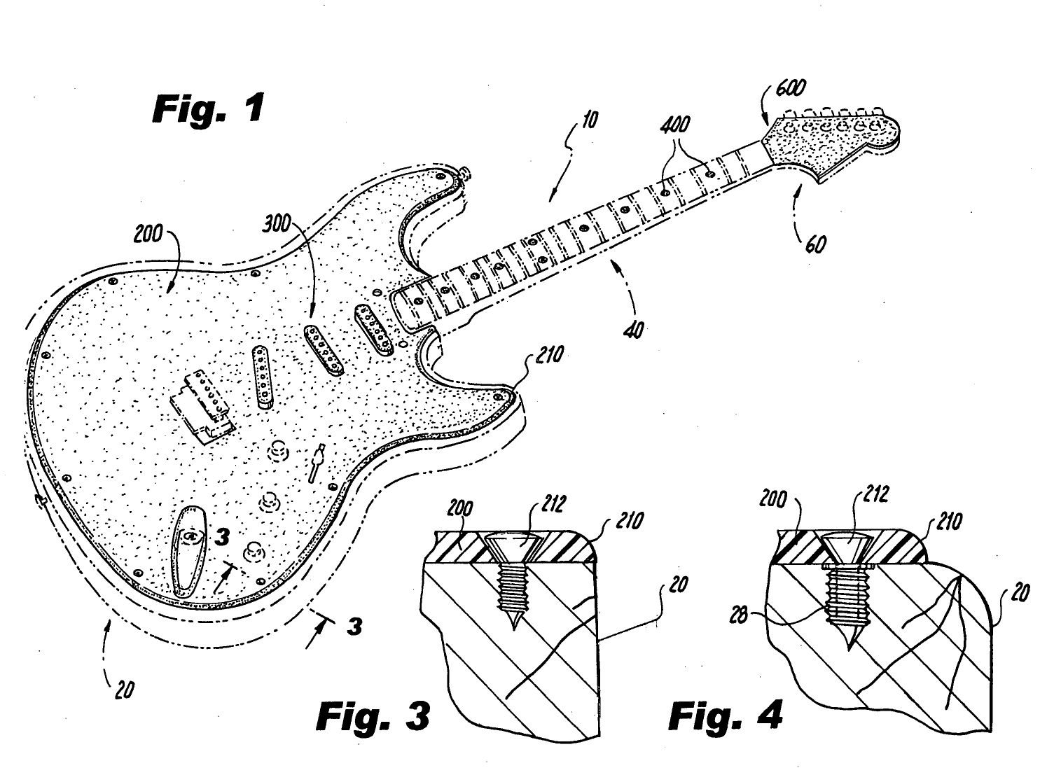

FIG. 1 illustrates these features on guitar 10 with body 20 having upper surface 22, neck 40, and peg head stock 60. The features of this invention, top cover 200 and head stock cover 600, are also shown in proper relation to guitar 10.

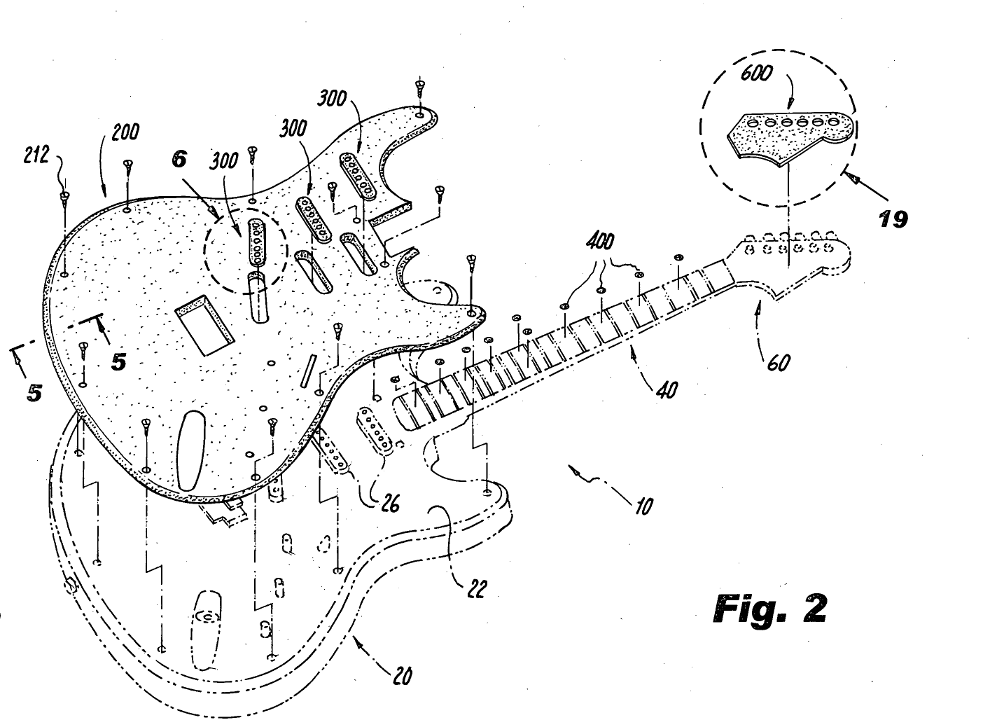

FIG. 2 is an exploded view which shows pick-up covers 300 for guitar pickups 26 more clearly.

Removable attachment of covers 200 and 600 can be achieved by using screw fasteners 212 either directly into the top surface 22 material, as shown in FIG. 3 or alternatively using an insert anchor 28 as shown in FIG. 4. These are two crossectional detail drawings.

For example, FIG. 3 shows flathead screw 212 seated in a countersunk hole through cover 200 and engaged flush with the peripheral edge of top surface 22 of a flat body top oriented at ninety degrees to the upwardly extending arcuate continuous side wall.

FIG. 4 shows the use of insert anchor 203 fastened into top surface material 22 with screw 212 retaining cover 200 while engaged within insert anchor 28. In addition, FIG. 4 shows the application of retaining cover 200 attached over the flat top surface of a curved edge guitar 20, at the circumferential edge of the flat top surface thereof.

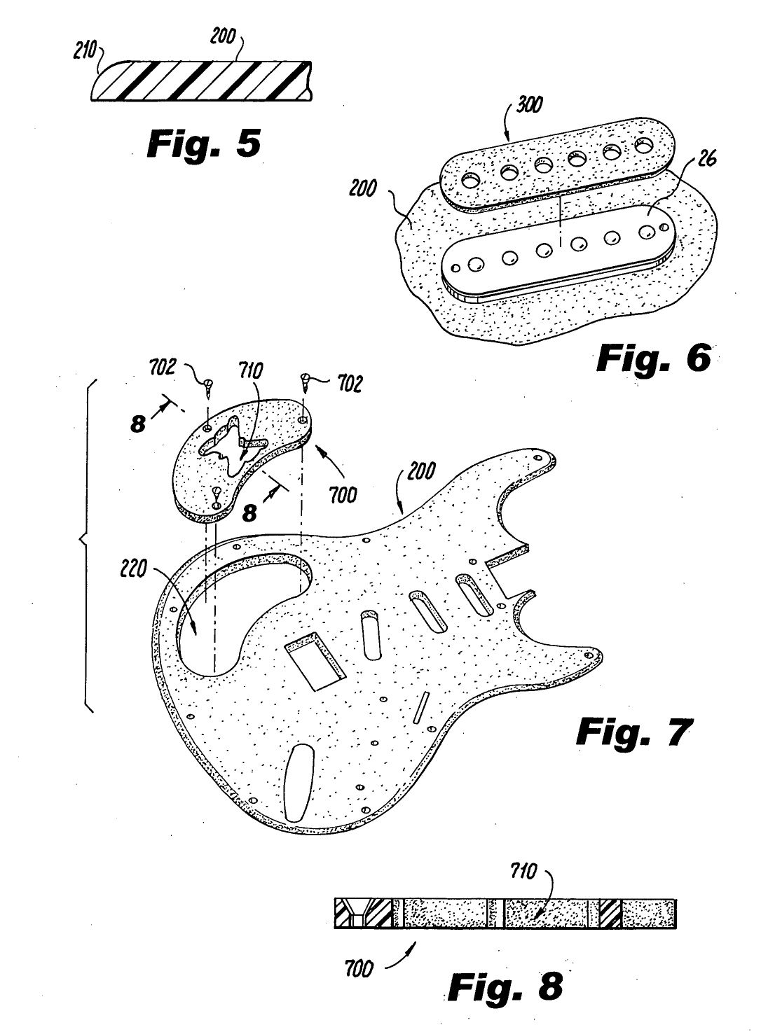

FIG. 5 is a crossectional detail of the arcuate radius edge 210 of guitar body 200. This edge is created by a routing process followed by rotary sanding using a hand power tool and a final hand sanding process.

FIG. 6 is a perspective view of a conventional pick-up cap 300 which is shown in relation to guitar 10 in FIG. 2, and which can be color or design coordinated with the decorative body cover 200 and/or head stock cover 600 of the present invention.

FIG. 7 illustrates an alternate embodiment of guitar cover 200 having aperture 220 which receives decorative insert plate 700 with decorative details 710. This is fastened with screws 702 which seat into top surface 22 of guitar body 20; this is also detailed in the crossection of FIG. 8 showing screw clearance holes in insert plate 700.

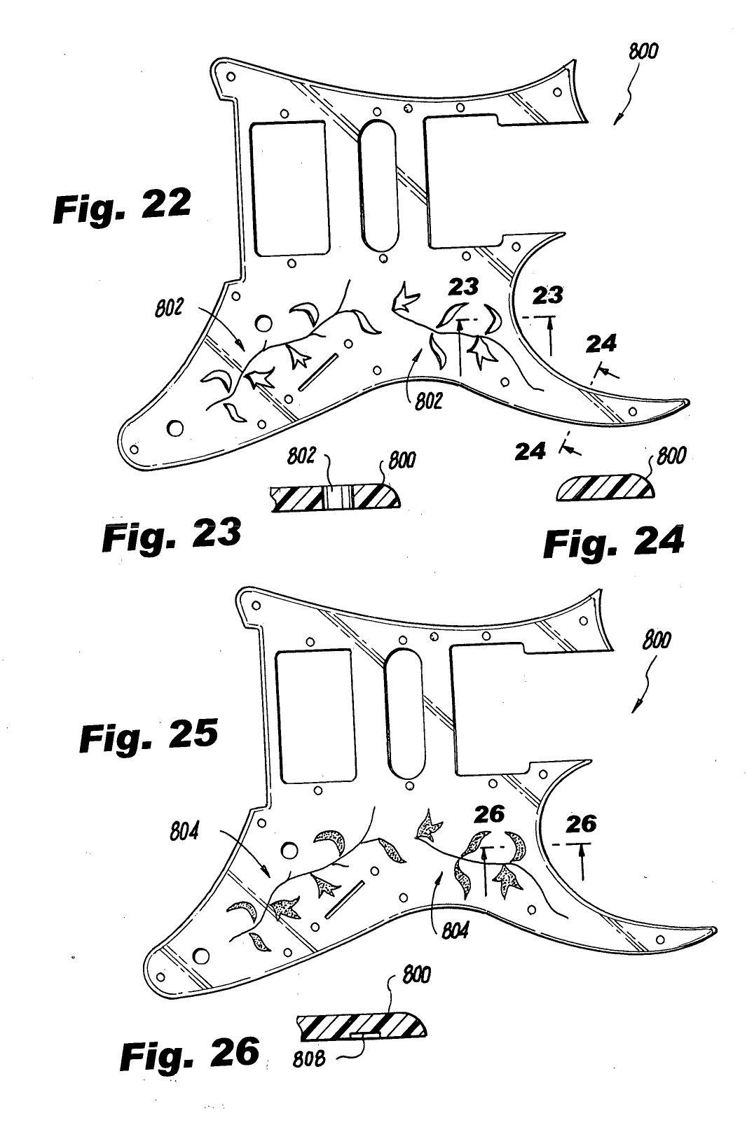

While FIG. 7 shows an oval-shaped decorative insert plate 700, any geometric shape may apply. Additionally, if the insert plate 700 is used in the area where a conventional pick guard 800 shown in FIG. 22, is used, the insert plate 700 can be embedded flush with the top of guitar 20, thereby obviating the need for a conventional auxiliary pick guard 800 extending up above the guitar top surface of guitar 20 and interfering with a smooth flush guitar top surface.

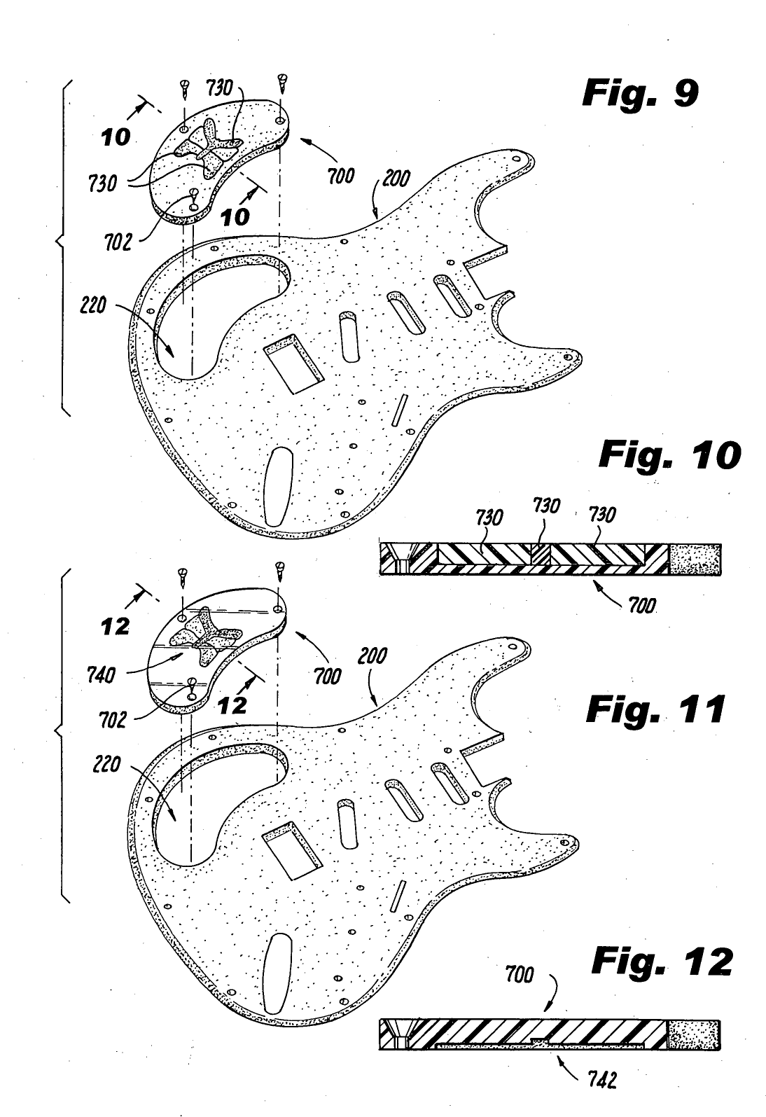

Variations in the decorating techniques of insert plate 700 are illustrated in FIGS. 9-12. In FIG. 9, a mosaic pattern 720 is used in the central portion of insert 700; crossection detail is shown in FIG. 10. FIG. 11 shows raster cut design 740 as seen from above in the center of insert plate 700. This is laser formed by etching the underside 742 of insert plate 700 as shown in crossection in FIG. 12.

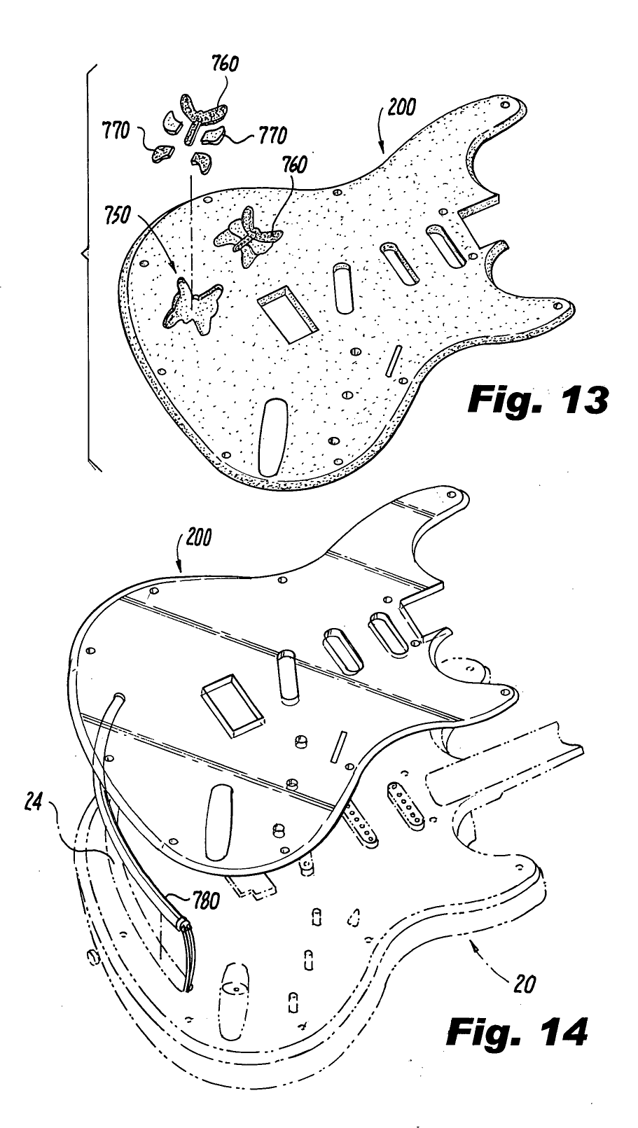

FIG. 13 shows an alternate guitar body cover 200 with mosaic style inlays 760 and 770 insertable in cutout 750.

FIG. 14 shows an exploded view of transparent or translucent guitar body cover 200 over an electroluminescent curved strip 780 which is fitted into a groove 24 of top surface 22 of guitar body 20. The light would illuminate cover 200.

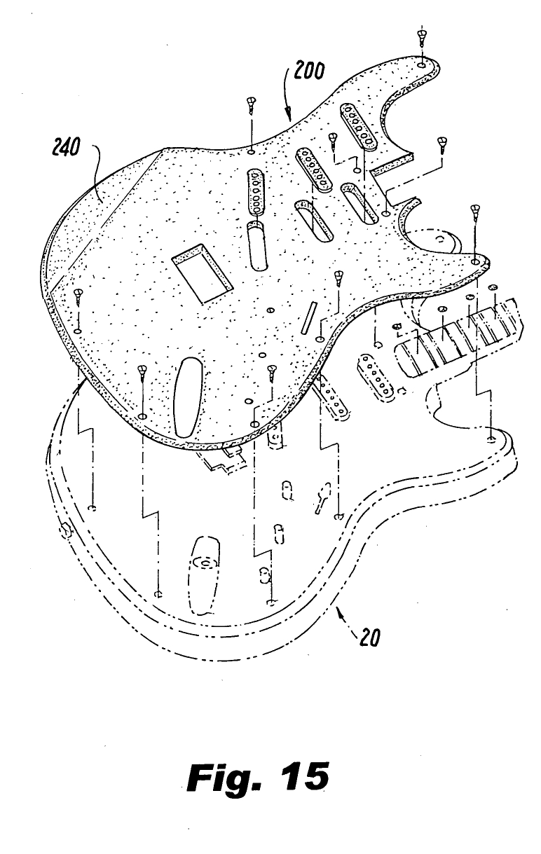

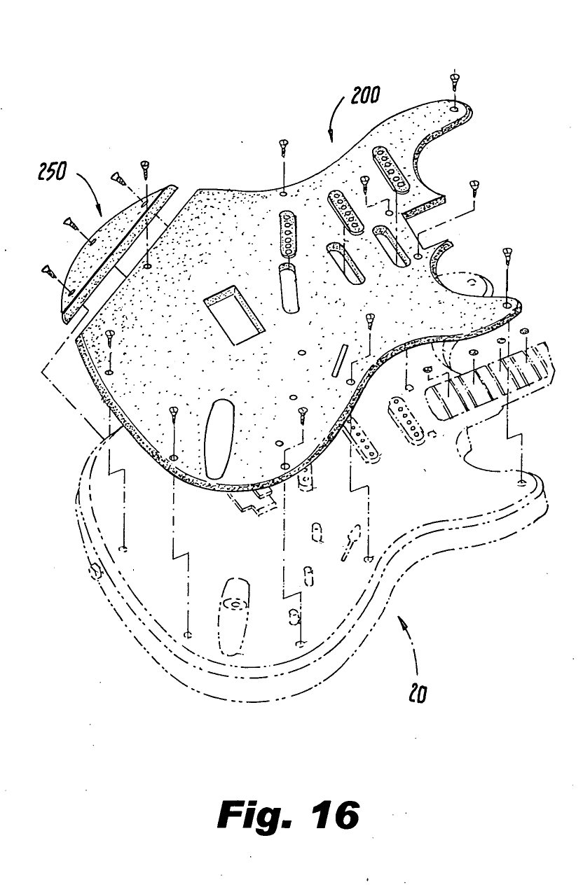

FIG. 15 shows a cover 200 with a bent wing 240 as a molded drape to cover a guitar body with such a body contour extension. In FIG. 16, a similar guitar body contour is accommodated with a main cover section 200 and a second separate piece 250.

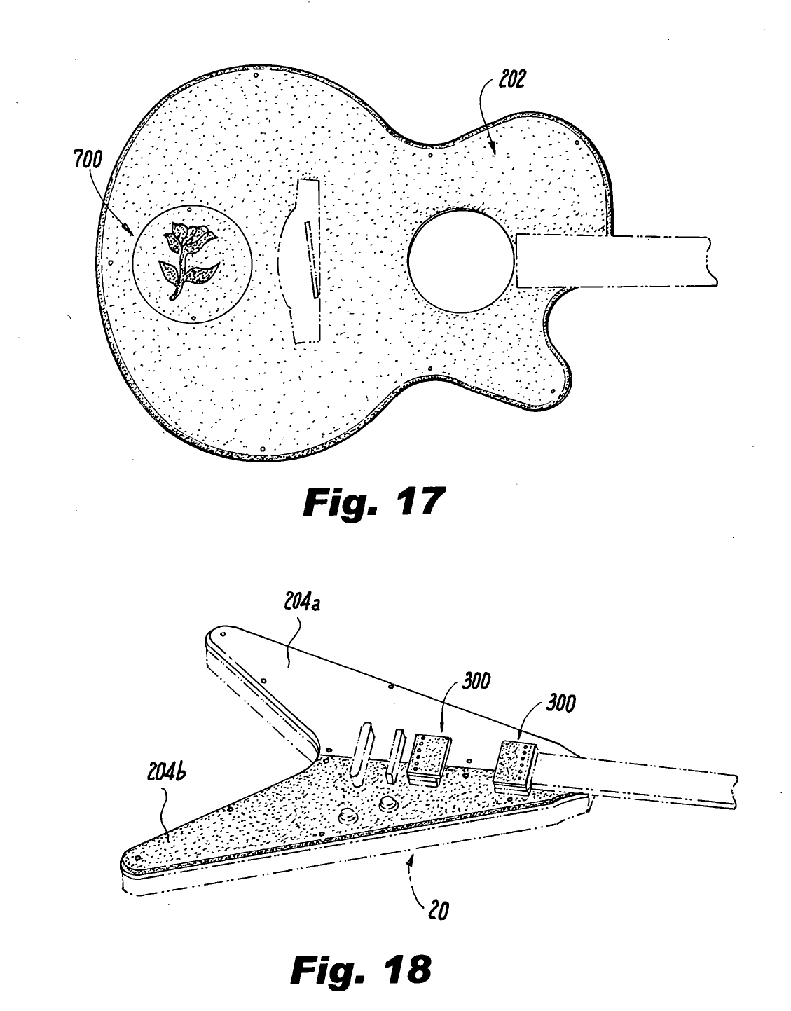

FIG. 17 shows a body cover 202 for an acoustic guitar; note sound hole in central area.

FIG. 18 is an exploded view of a guitar with a flying V style guitar body 20 covered by 2-piece body cover having sections 204a and 204b.

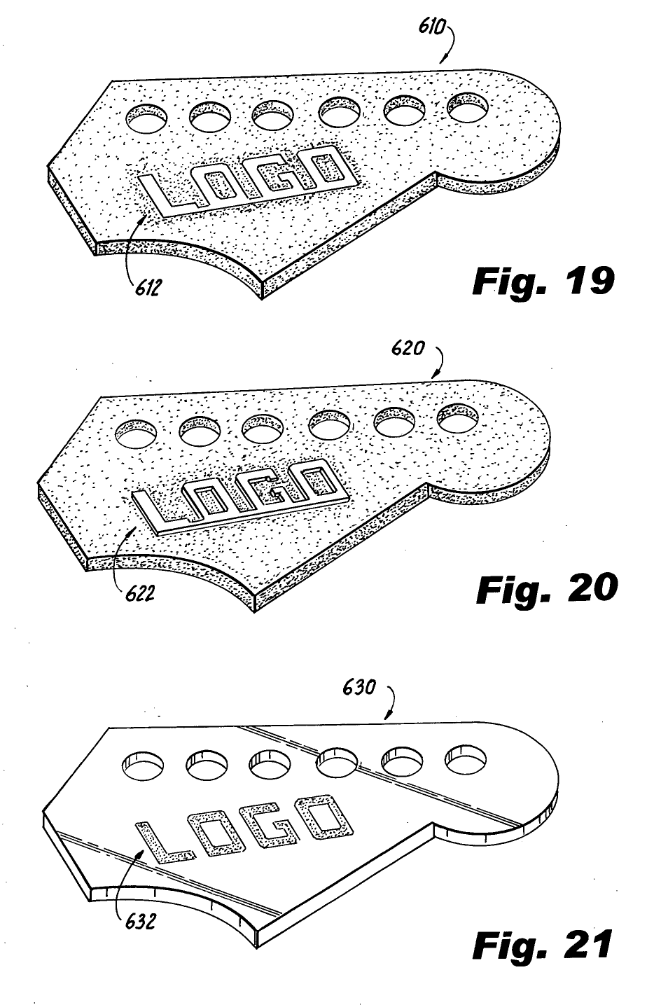

FIGS. 19-21 illustrate three different options for decorating head stock covers. FIG. 19 shows head stock cover 610 with flush logo insert 612. FIG. 20 shows cover 620 with raised insert logo 622, while FIG. 21 shows cover 630 with raster cut logo 632.

FIGS. 22-26 relate to conventional pick guards, which can be improved by color or design coordinating with those unique features of the decorative body cover 200 and/or head stock cover 600 of the present invention. Unlike the decorative body cover 200, which covers the entire top flat surface of the guitar body 20 or the decorative head stock cover 600, which covers the entire flat top surface of a head stock 60, a pick guard is a conventional protective guitar accessory for protecting a limited portion of the guitar top in the area where the pick may damage the body surface. However, it does not cover the entire surface of the guitar top in a color and design coordinated manner as does the guitar top cover of the present invention. Therefore, FIG. 22 shows that, when embellished with design components of the present invention, pick guard 800 may additionally have laser cutting 802 or rastered engraving 804. FIG. 23 is a related crossectional view. FIG. 24 is a second crossectional view; it shows an edge detail 810 which is radiused. FIG. 25 shows an alternative decorating 804 of pick guard 800 incorporating rastered imaging. FIG. 26 shows a crossection view which illustrates the undercuttings 808 which form raster image 804 as seen from the top of pick guard cover 800.

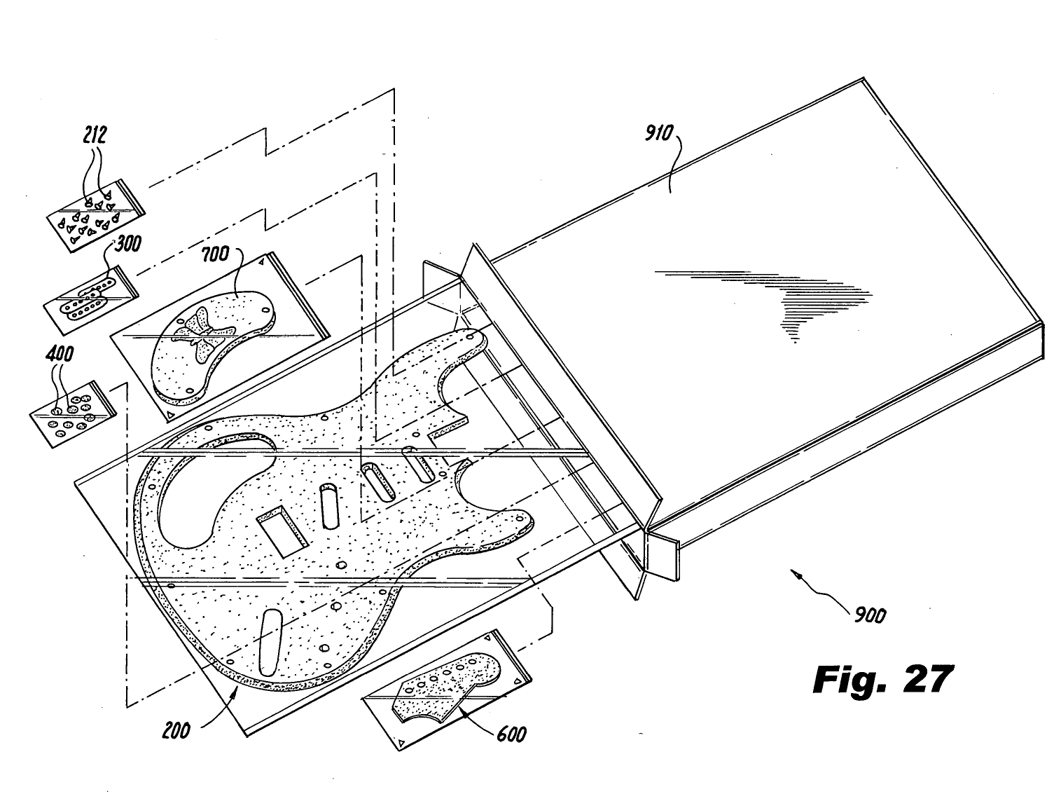

FIG. 27 shows all of the components of a guitar decorating kit including the kit box 910. Included are body top cover 200, head stock cover 600, conventional pick-up caps 300, and conventional dots to decorate neck 400.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

We claim:

1. An interchangeable cover for and in combination with a guitar comprising:
said guitar having a body, a neck, and a headstock, each of said body, neck and headstock having a front face;
a removable cover for the front face of said body having an outline corresponding to an outline of the front face of said body;
fasteners along a periphery of said removable cover for attaching said cover to said front face of said body.

2. The interchangeable cover of claim 1 in which the periphery of said cover has a rounded and polished edge.

3. The interchangeable cover of claim 2 in which said fasteners are threaded members.

4. The interchangeable cover of claim 1 in which said cover has an aperture filled with a replaceable decorative insert.

5. The interchangeable cover of claim 4 in which said decorative insert comprises one or more pieces of mosaic inlay.

6. The interchangeable cover of claim 4 in which said decorative insert has an rastered image engraved thereon.

7. The interchangeable cover of claim 1 in which said cover has multiple apertures with replaceable decorative inserts with different design features.

8. The interchangeable cover of claim 1 having a strip light embedded in the face of said body, said cover being transparent over an area above said strip light.

9. The interchangeable cover of claim 1 in which the face of said body has a surface which is contoured, said cover having a matching contoured surface.

10. The interchangeable cover of claim 1 in which said cover is an assembly of pieces to fit a specially contoured guitar body.

11. The interchangeable cover of claim 1 having a cover for said headstock.

12. The interchangeable cover of claim 11 in which the headstock cover has a flush inlay insert image.

13. The interchangeable cover of claim 11 in which the headstock cover has a raised inlay insert image.

14. The interchangeable cover of claim 11 in which the headstock cover has a reverse side raster cut image.

15. A kit of interchangeable covers for and in combination with a guitar comprising:
said guitar having a body, a neck, and a headstock, each of said body, neck and headstock having a front face;
a number of different removable covers for the front face of said body each having an outline corresponding to an outline of the front face of said body;
fasteners along a periphery of each removable cover for attaching to said front face of said body.

16. An interchangeable cover for and in combination with a guitar comprising:
said guitar having a body, a neck, and a headstock, each of said body, neck and headstock having a front face;
a removable cover for the front face of said body having an outline corresponding to an outline of the front face of said body;
fasteners along a periphery of said removable cover for attaching said cover to said front face of said body;
and wherein the periphery of said cover has a rounded and polished edge.

17. An interchangeable cover for and in combination with a guitar comprising:
said guitar having a body, a neck, and a headstock, each of said body, neck and headstock having a front face;
a removable cover for the front face of said body having an outline corresponding to an outline of the front face of said body;
fasteners along a periphery of said removable cover for attaching said cover to said front face of said body;
a periphery of said cover having a rounded and polished edge;
said cover having at least one aperture filled with a replaceable decorative insert.

18. The interchangeable cover of claim 17 in which said decorative insert comprises one or more pieces of mosaic inlay.

19. The interchangeable cover of claim 17 in which said decorative insert has an rastered image engraved thereon.

20. The interchangeable cover of claim 17 in which said cover has multiple apertures with replaceable decorative inserts with different design features.

21. The interchangeable cover of claim 17 having a strip light embedded in the face of said body, said cover being transparent over an area above said strip light.

22. A method for making a polished, radiused rounded edge provided along the edge of a guitar comprising the steps of:
cutting a beveled straight crossectional edge along the edge of the guitar;
routing and sanding said beveled edge thereof with a router sander having a round-over bit into a curved arcuate shape; and,
finely polishing said curved arcuate shape by hand with a fine wet sand grit paper.
